(19) United States
(12) Patent Application Publication
(10) Pub. No.: US 2006/0273277 A1
(43) Pub. Date: Dec. 7, 2006

(54) Plasma resistant seal assembly with replaceable barrier shield

(76) Inventors: Mark James Heller, Newark, DE (US); Leslie L. Feeney, Bear, DE (US)

Correspondence Address: DUPONT PERFORMANCE ELASTOMERS L.L.C., PATENT RECORDS CENTER, 4417 LANCASTER PIKE, BARLEY MILL PLAZA P25, WILMINGTON, DE, 19805, US

(21) Appl. No.: 11/414,848

(22) Filed: May 1, 2006

Related U.S. Application Data
(60) Provisional application No. 60/686,704, filed on Jun. 2, 2005.

(51) Int. Cl. F16K 1/00

(52) U.S. Cl. 251/334

(57) ABSTRACT

The seal assemblies of this invention comprise a closure assembly having first and second grooves, with a rubber seal mounted in said first groove and a removably mounted, replaceable barrier strand in said second groove, said barrier located between the rubber seal and a plasma source, whereby said barrier shields the rubber seal from erosive effects of the plasma.

### CROSS REFERENCE TO RELATED APPLICATIONS

This application claims the benefit of U.S. Provisional Application No. 60/686,704 filed Jun. 2, 2005

### FIELD OF THE INVENTION

This invention relates to a seal assembly having a replaceable barrier which shields an elastomeric seal from direct exposure to a plasma.

### BACKGROUND OF THE INVENTION

Elastomer sealing components used in equipment for manufacture of electronic components, for example semi-conductor devices, must meet unusually stringent property requirements. Specifically, the seals are often exposed to reactive plasmas, corrosive cleaning gases and high temperatures that may cause degradation of the elastomer, resulting in loss of physical properties and generation of residue material which may contaminate the semi-conductor devices being manufactured.

Typically, elastomer parts which will be exposed to plasmas in semiconductor manufacturing equipment are fabricated from perfluoroelastomers, fluoroelastomers or silicone elastomers because of their natural resistance (listed in decreasing order) to reactive plasmas. However, even perfluoroelastomers degrade over time when exposed to reactive plasmas. Seal life is dependent on the severity of the exposure environment and the proximity to the plasma environment.

Others have improved the plasma resistance of perfluoroelastomer seals by judicious selection of compounding additives. For example, Legare (U.S. Pat. No. 5,696,189) substituted a metallic filler for carbon black and included titanium dioxide and an acid acceptor in his elastomer seal compositions. Katsuhiko et al. (JP 3303915 B2) employed fine particle size aluminum oxide in elastomer seal compositions. Both patents disclose seals having improved resistance to attack by plasmas and reduced residue formation.

Another method for protecting rubber seals from attack by plasma is to place a sacrificial shield between the plasma and the rubber seal. Shields are typically made from a material that is resistant to plasma attack or materials that do not leave behind harmful particulate when the material is attacked or consumed. Such materials include polytetrafluoroethylene (PTFE), the copolymer of tetrafluoroethylene and perfluoro(propyl vinyl ether) (PFA), polyetheretherketone (PEEK), polyphenylene sulfide (PPS) and polyimides. In use, such a shield extends from the body on which the rubber seal is mounted to contact the body to which the rubber part is forming a seal.

Commercially available seal and barrier shield assemblies comprise a bonded rubber seal and a continuous ring barrier that must be installed when the assembly is manufactured. Neither the bonded rubber seal, nor the barrier shield ring may be readily replaced in the field. Thus, the entire assembly must be replaced whenever either the barrier or rubber seal needs to be replaced. While these assemblies do protect the primary rubber seal and extend overall seal life, they require that the whole seal and barrier shield assembly be replaced and therefore are more expensive. It is desirable to minimize consumables cost while maintaining the seal life associated with seal and barrier shield assemblies.

U.S. Pat. No. 5,722,668 discloses elastomeric seals which are, at least partially covered by a shield collar which protects the elastomer from plasma attack until the shield is eroded through by the plasma. When the latter occurs, both the elastomer seal and shield collar must be replaced.

U.S. Pat. No. 6,245,149 B1 discloses elastomeric seals which are protected from plasma attack by a barrier shield which is a linear strand having notched, slideably coupled ends. The shield is arranged in the same groove as the elastomer seal in a location between the seal and the plasma. Eventually, the plasma will erode through the shield and both shield and elastomer seal need to be replaced.

EP 1087157 A2 discloses various embodiments of an elastomer seal—barrier shield assembly. In all embodiments, the seal and shield are in contact within the same groove. One embodiment is an elastomer shield having a barrier shield attached to its outer surface. Other embodiments employ shields which are not physically joined to the elastomer seal. In all cases, when the barrier has been eroded through, both seal and barrier shield must be replaced.

In dynamic slit valve or gate valve door seal applications the prior two designs are not practical because it is difficult to retain the seal and shield in the same groove during valve actuation.

U.S. Pat. No. 6,764,265 B2 discloses a valve having elastomeric seals which are protected from plasma attack by a barrier shield. The seal and shield are mounted on the valve seat, rather than the valve closure, and oriented so as to be removed from a direct line of sight of the plasma source. The barrier shield and elastomeric seals are located in separate grooves. Both the seal and shield may be physically bonded to the valve seat or they may be physically fixed to the seat by placement within a notch, groove, or other feature. Bonding seals and shields to the valve seat would require replacement of the valve seat whenever the seal or barrier needed to be replaced.

### SUMMARY OF THE INVENTION

An aspect of the present invention is a seal assembly comprising a closure assembly having first and second grooves, an elastomer seal mounted in said first groove and a replaceable barrier strand removably mounted in said second groove whereby said barrier strand shields said elastomer seal from direct exposure to reactive plasma.

Another aspect of the invention is a slit valve door for use in semiconductor wafer processing equipment, said door having mounted thereon an elastomer seal in a first groove and a replaceable barrier strand removably mounted in a second groove, said barrier strand for shielding the rubber seal from direct exposure to reactive plasma.

### BRIEF DESCRIPTION OF THE DRAWINGS

FIG. 1 shows a cross-sectional view of an embodiment of a seal assembly of the invention in the uncompressed state wherein the elastomeric seal is bonded or molded to the closure assembly within a first groove and the barrier strand is removably mounted within a second groove.

FIG. 2 shows a cross-sectional view of an embodiment of a seal assembly of the invention in the compressed state wherein the elastomeric seal is bonded or molded to the closure assembly within a first groove and the barrier strand is removably mounted within a second groove.

FIG. 3 shows a plan view of a slit valve door of this invention.

FIG. 4 shows a cross-sectional view of an alternative embodiment seal assembly of the invention in the uncompressed state wherein the elastomeric seal is removably mounted in a first groove on the closure assembly and the barrier strand is removably mounted within a second groove.

FIG. 5 shows a cross-sectional view of an alternative embodiment seal assembly of the invention in the compressed state wherein the elastomeric seal is removably mounted in a first groove on the closure assembly and the barrier strand is removably mounted within a second groove.

FIG. 6 shows cross-sectional views of several embodiments of the barrier strand.

### DETAILED DESCRIPTION OF THE INVENTION

The seal assembly of this invention comprises a rubber (i.e. elastomeric) seal and a removably mounted (i.e. replaceable) barrier shield strand on a closure assembly. The seal and barrier shield strand are in within separate grooves on the closure assembly. The elastomeric seal may be permanently bonded to the closure assembly, or optionally, may be removably mounted to the closure assembly (i.e. the seal may be replaceable). When in use, the barrier shields the rubber seal from direct exposure to a reactive plasma. Direct exposure to plasma would cause erosion of the rubber which, in turn, would result in both seal failure and possible contamination of nearby surfaces with particles from the eroded seal. Because the barrier strand is removably mounted on the closure assembly in a separate groove from the seal, the strand may be replaced, after erosion, with a new barrier so that the useable lifetime of the rubber seal is increased. Eventually, the rubber seal will fail. At that time, either the entire seal assembly must be replaced, or in the embodiment having a replaceable seal, only the seal need be replaced.

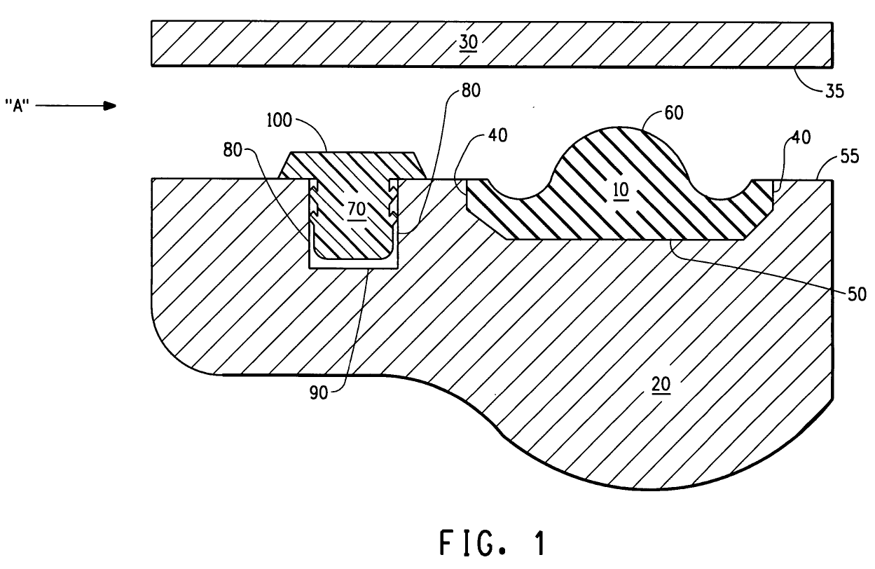

Referring to FIG. 1, one embodiment of this invention is a seal assembly comprising a closure assembly 20 on which a rubber seal 10 is mounted, and a seal seat 30, having a face 35 against which seal 10 is compressed to form a seal when in use. Seal 10 may be bonded directly onto surface 55 of closure assembly 20 (not shown), or, preferably, it may be bonded within a first groove or notch having side walls 40 and base 50 as shown in FIG. 1. Bonding may be accomplished by use of a chemical bonding agent, a mechanical bond, vulcanizing the elastomer seal under pressure and temperature onto the closure assembly, or by a combination of two or three of these known techniques. By “mechanical bonding” is meant roughening the surface of the seal, closure assembly, or both to enhance adhesion of the seal to the closure assembly. Seal 10 has a sealing surface 60 for contacting face 35 of seal seat 30 when in use. Seal 10 may have a generally parabolic cross-section as shown, or it may have any of the well-known cross-sections such as circular, dovetail-shaped, trilobe, dome-shaped, etc. The arrow marked “A” shows the direction that plasma enters the seal assembly.

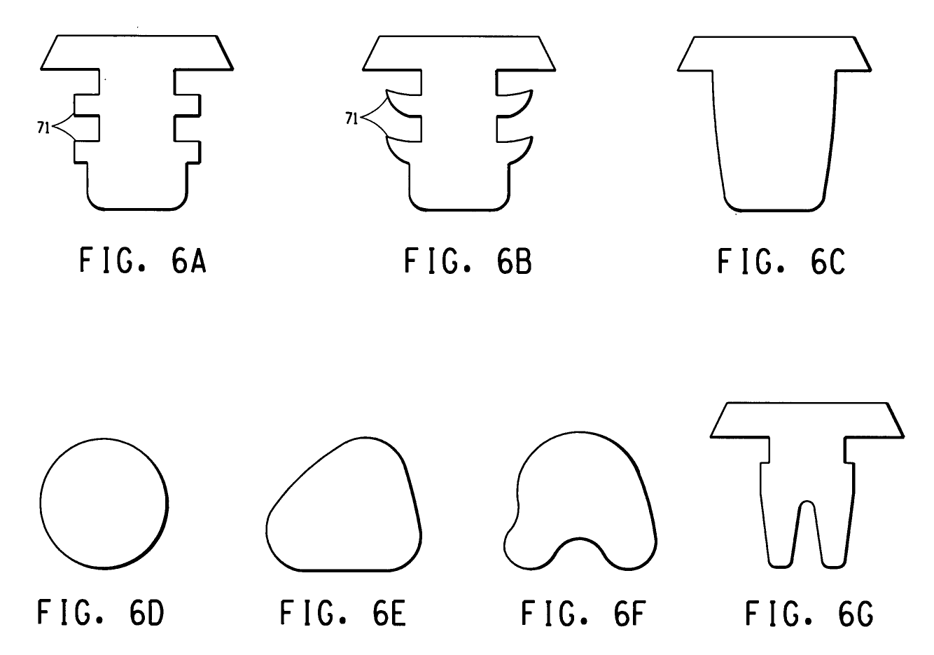

Barrier strand 70 forms a shield so that the majority of the plasma does not have a direct path to seal 10. Barrier strand 70 is removably mounted in a second groove or notch having side walls 80 and base 90 as shown in FIG. 1. The groove or notch may have a generally rectangular shape as shown, or alternatively, the side walls of the groove may be notched, serrated, or barbed to improve retention of the shield in the groove once strand 70 is seated. Depending on the cross-sectional configuration of the barrier strand, the groove may also have a dovetail shape. Barrier strand 70 has a mating surface 100 for contacting face 35 of seal seat 30 when in use. The preferred cross-section for barrier strand 70 is generally T-shaped with one or more lateral fins or ribs 71 as shown in FIG. 6a. Fins or ribs 71 can be perpendicular to the base of the “T” cross-section and be rectangular in shape as shown or they may have a barbed shape similar to that of a dorsal fin (FIG. 6b). In either case, ribs or fins 71 help to make the barrier strand easier to install in the groove without the use of special tools. Ribs or fins 71 also aid in the retention of strand 70 within the groove by engaging one or more groove walls 80. Since the materials commonly employed for barrier strand construction are engineering plastics that are not forgiving and lack elastic properties, it is necessary to incorporate flexibility into the design of the barrier strand to facilitate easy installation. Alternatively, the barrier strand may have other cross-sectional shapes such as “T” shaped without fins, circular, dovetail shaped, trilobal, tooth-shaped, etc. as shown in FIGS. 6c, 6d, 6e, 6f and 6g respectively and can be used in a standard groove configuration as shown or in a dovetail shaped groove. However, retention of barrier strand 70 within the second groove is dependent upon an interference fit, and if these alternative cross-sectional shapes do not have flexibility built into the design, they may be more difficult to install in the groove without the use of special tools. Dovetail-shaped seals and trilobe-shaped seals are described in U.S. Pat. Nos. 5,482,297 and 6,328,316, respectively. Barrier strand 70 is made to a length whereby it runs the length of seal 10, thus shielding the latter from direct plasma attack. A strand is preferred because it is easier to mount to and remove from the second groove of closure assembly 20 than it is to mount and remove a continuous barrier ring. The ends of barrier strand 70 meet in a butt joint, i.e. the ends do not overlap in the groove and are not slideably coupled.

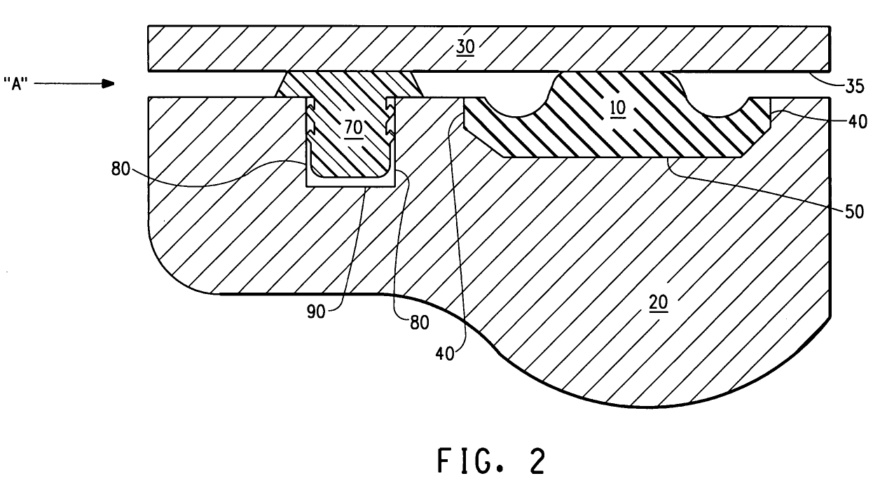

When in use, barrier 70 contacts face 35 of seal seat 30 and seal 01 is compressed against face 35 of seal seat 30 (FIG. 2).

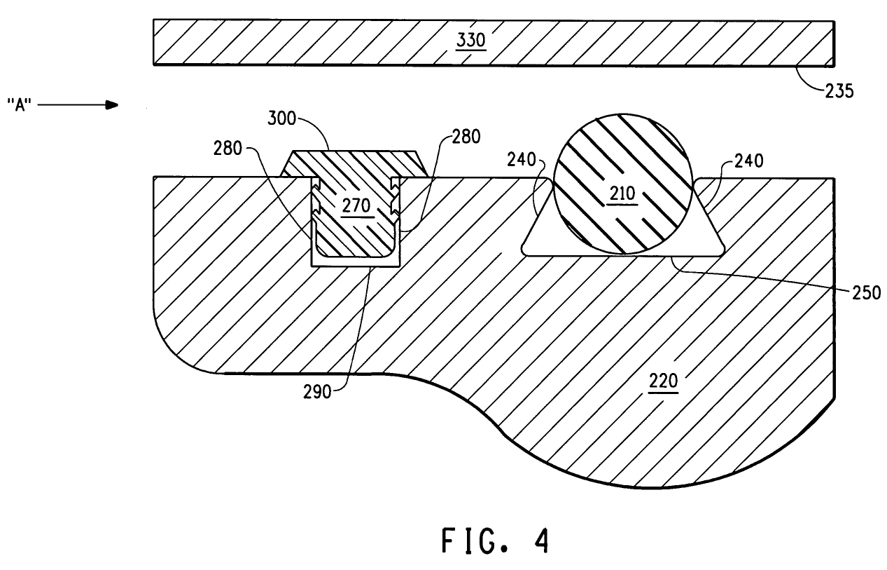

In an alternative embodiment of this invention, FIG. 4, elastomer seal 210 is removably mounted in a first groove having sidewalls 240 and a base 250. The groove shape may be any of those known in the industry such as generally rectangular, dovetail, half dovetail, etc. The cross-section of rubber seal 210 may be generally circular as shown, or it may be any shape known in the rubber seal industry such as trilobal, elliptical, dovetail-shaped, etc.

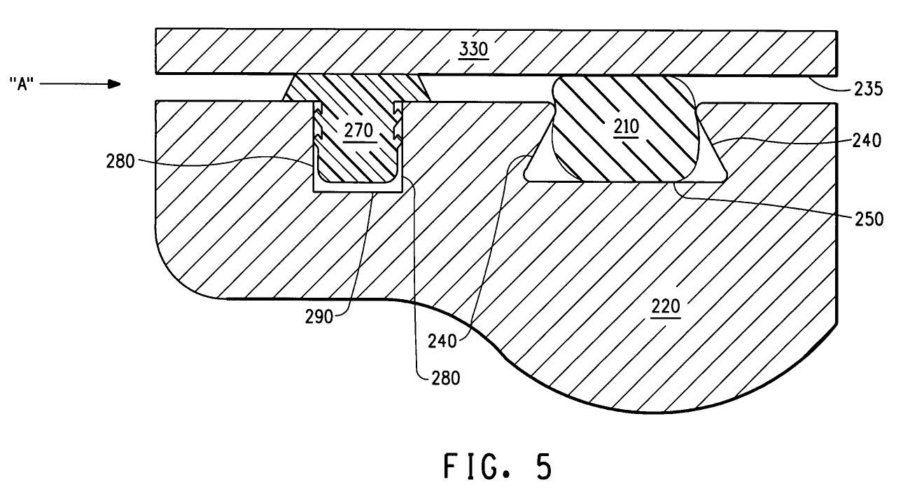

When in use, barrier 270 contacts face 235 of seal seat 330 and seal 210 is compressed against face 235 of seal seat 330 (FIG. 5).

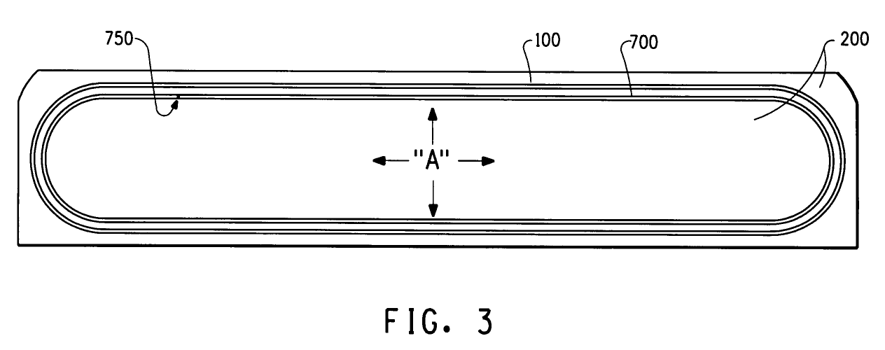

Another embodiment of this invention is a slit valve door. Referring to FIG. 3, door 200 is a closure assembly having first and second grooves or notches for receiving rubber seal 100 (which may optionally be replaceable) and replaceable barrier strand 700. Barrier strand 700 has non-overlapping ends that meet in a butt joint 750. When in use, plasma flows from the center of door 200 outward toward the periphery of the door, as indicated by the arrows emanating from “A”.

Elastomers suitable for use in seals 10, 100 and 210 of this invention include, but are not limited to perfluoroelastomers, fluoroelastomers, silicones, nitrile rubbers and ethylene elastomers such as chlorinated polyethylenes, EPDM, ethylene/olefin copolymers, etc. Perfluoroelastomers, fluoroelastomers and silicone rubbers are preferred. Perfluoroelastomers are especially preferred. Typical perfluoroelastomers, fluoroelastomers and suitable curative systems have been well described in the art. See for example, U.S. Pat. Nos. 6,281,296 B1; 6,114,452; 5,789,489; 4,214,060; and 3,876,654.

Additives, such as fillers, stabilizers, plasticizers, lubricants, and processing aids typically utilized in elastomer compounding can be incorporated into the elastomer parts of the present invention, provided that they have adequate stability for the intended service conditions.

Fillers such as carbon black, fluoropolymers, polyimides, and inorganic fillers (e.g. silicon dioxide, aluminum oxide, aluminum silicate, and barium sulfate) are used in elastomer compositions employed in this invention as a means to balance modulus, tensile strength, elongation, hardness, abrasion resistance, plasma resistance, and processability of the compositions. Fluoropolymer fillers (fibrillated or non-fibrillated) can be any finely divided, easily dispersed plastic fluoropolymer that is preferably solid at the highest temperature utilized in fabrication and curing of the elastomer composition. By solid, it is meant that the fluoroplastic, if partially crystalline, will have a crystalline melting temperature above the processing temperature(s) of the elastomer(s). Such finely divided, easily dispersed fluoroplastics are commonly called micropowders or fluoroadditives. When used in the compositions of this invention, 1-70 parts by weight filler per 100 parts by weight rubber (i.e. elastomer) (phr) is generally sufficient.

A whitener, such as titanium dioxide may also be present in the elastomer compositions employed in this invention.

Closure assemblies 20, 220, door 200 and seal seats 30 and 330 may be made from metals such as stainless steel or aluminum, e.g. 6061-T6 aluminum. Preferably, closure assembly 20 and seal seat 30 are made from the same material.

Barrier strand 70, 270 and 700 may be made from a non-elastic fluoropolymer such as polytetrafluoroethylene (PTFE) or the copolymer of tetrafluoroethylene with a perfluoro(alkyl vinyl ether) (PFA). Other barrier materials may include, but are not limited to polyetheretherketone (PEEK), polyphenylene sulfide (PPS) and polyimides. PTFE is preferred.

The seal assemblies of this invention are particularly suited for use in dry process semiconductor wafer manufacturing processes where they will be subjected to reactive plasma environments. Specific applications include, but are not limited to door seals, pendulum valve seals and lid seals. One preferred end use application for the elastomer parts of this invention is as slit valve door seals.

What is claimed is:

1. A seal assembly comprising a closure assembly having first and second grooves, an elastomer seal mounted in said first groove and a replaceable barrier strand removably mounted in said second groove whereby said barrier strand shields said elastomer seal from direct exposure to reactive plasma.

2. A seal assembly of claim 1 wherein said elastomer seal is bonded within said first groove.

3. A seal assembly of claim 1 wherein said elastomer seal is removably mounted in said first groove.

4. A seal assembly of claim 1 wherein said elastomer seal is a perfluoroelastomer seal.

5. A seal assembly of claim 1 wherein said elastomer seal has a parabolic-shaped cross-section.

6. A seal assembly of claim 1 wherein said barrier strand comprises a polymer selected from the group consisting of polytetrafluoroethylene, PFA, polyetheretherketone, polyphenylene sulfide and a polyimide.

7. A seal assembly of claim 6 wherein said barrier strand comprises polytetrafluoroethylene.

8. A seal assembly of claim 1 wherein said barrier strand has at least one rib for engaging at least one wall of said second groove.

9. A seal assembly of claim 8 wherein said barrier strand has a T-shaped cross-section.

10. A slit valve door for use in semiconductor wafer processing equipment, said door having mounted thereon an elastomer seal in a first groove and a replaceable barrier strand removably mounted in a second groove, said barrier strand for shielding the rubber seal from direct exposure to reactive plasma.

11. A slit valve door of claim 10 wherein said elastomer seal is bonded within said first groove.

12. A slit valve door of claim 10 wherein said elastomer seal is removably mounted in said first groove.

13. A slit valve door of claim 10 wherein said elastomer seal is a perfluoroelastomer seal.

14. A slit valve door of claim 10 wherein said elastomer seal has a parabolic-shaped cross-section.

15. A slit valve door of claim 10 wherein said barrier strand comprises a polymer selected from the group consisting of polytetrafluoroethylene, PFA, polyetheretherketone, polyphenylene sulfide and a polyimide.

16. A slit valve door of claim 15 wherein said barrier strand comprises polytetrafluoroethylene.

17. A slit valve door of claim 10 wherein said barrier strand has at least one rib for engaging at least one wall of said second groove.

18. A slit valve door of claim 17 wherein said barrier strand has a T-shaped cross-section.
